(19) United States
(12) Patent Application Publication
(10) Pub. No.: US 2014/0199672 A1
(43) Pub. Date: Jul. 17, 2014

(54) TRAINING APPARATUS AND METHODS

(71) Applicant: Lance S. Davidson, Scottsdale, AZ (US)

(72) Inventor: Lance S. Davidson, Scottsdale, AZ (US)

(21) Appl. No.: 14/157,491

(22) Filed: Jan. 16, 2014

Related U.S. Application Data
(63) Continuation-in-part of application No. 13/655,039, filed on Oct. 18, 2012, now abandoned.
Application No. 13/655,039 is a continuation of application No. 10/410,082, filed on Apr. 9, 2003, now abandoned.
(60) Provisional application No. 60/370,595, filed on Apr. 9, 2002.

(51) Int. Cl. G09B 19/00

(52) U.S. Cl. CPC G09B 19/003
USPC 434/247

(57) ABSTRACT

A system and apparatus for allowing a trainee to replicate the body movements of a trainer. A trainer's instructional body movements are recorded using sensors on the trainer's garment and then stored in a computer. A trainee's body movements are then recorded using a similar set of sensors on the trainee's garment. The computer can then compare the trainer and trainee body movements to assist the trainee in better replicating the trainer's body movements. The trainee's garment can be provided with physical devices, such as neuromuscular electrical stimulators and/or robotic actuators, to physically assist the trainee in real time to better replicate the trainer's body movements. Such physical devices may also be included on the trainer's garment so that the trainer can better understand any mistakes made by the trainee.

### CROSS REFERENCE TO RELATED APPLICATIONS

This application is a continuation-in-part of U.S. patent application Ser. No. 13/655,039, filed Oct. 18, 2012, which was a continuation of U.S. patent application Ser. No. 10/410,082, filed on Apr. 9, 2003, which claimed priority to U.S. Provisional Patent Application Ser. No. 60/370,595, filed on Apr. 9, 2002. The contents of these patent applications are hereby incorporated by reference in their entirety.

### BACKGROUND OF THE INVENTION

1. Technical Field

The present invention relates to an advanced training system to assist a trainee to replicate the body movements of a trainer.

2. Description of the Related Art

The role of a coach or physical therapist is to enable the athlete or rehabilitation patient to achieve levels of performance that may not be possible if the athlete or patient is left to his own endeavors. A wise coach develops not only the fullest physical potential in his charges, but also those capacities and habits of mind and body which will enrich and ennoble their later years. Effective training in a particular activity, whether golf, skiing, fly-fishing, cycling, running, swimming, and batting, to name but only a few of many types of physical activities, requires repetition, mental focus, dedication, perseverance, and a judicious and experienced coach for supplying the student with the necessary instruction, tools, motivation, and experience for helping the student achieve his/her maximum potential. Not everyone has access to a coach. As a result, many inherently talented or physically impaired people throughout the world fail to reach their full potential in their chosen activities.

Thus, there is a need in the art for advanced training systems and methods that are efficient and reliable. Another object of the invention is to provide improved training systems and methods that do not require a coach. Still a further provision of the invention is to provide improved training systems and methods that exploit the advancements in computer technology and systems for tracking body movement.

### BRIEF SUMMARY OF THE INVENTION

The present invention provides ways to assist a trainee to replicate the body movements of an experienced trainer. This is generally accomplished by making a computer model of the trainer's movements and comparing those trainer movements to the trainee's movements. In some embodiments, reports are generated comparing the respective trainer and trainee body movements. In other embodiments, the trainee is assisted in replicating the trainer's movements through physical devices, such as neuromuscular electrical stimulators and/or robotic actuators, to physically assist the trainee's body movements.

A first embodiment consists of a system for collecting a trainer or reference body movement model. The same or different system is used for collecting a trainee body movement model. A computer is associated with the system(s) for comparing the trainee body movement model to the trainer body movement model and generating a report comparing the trainee body movement model to the trainer body movement model. The report includes an identification of similarity between the trainee body movement model and the trainer body movement model. The report can also include an identification of dissimilarity between the trainee body movement model and the trainer body movement model. The report can still further include remedial instructional information explaining how to correct the trainee body movement model to conform substantially to the trainer body movement model.

Yet another embodiment consists of computer storage maintaining a database of trainer body movement models and a trainee body movement model collection system. The computer is operative for comparing a trainee body movement model collected by the trainee body movement model collection system to a designated one of the trainer body movement models and generating a report comparing the trainee body movement model to the designated trainer movement model. The report includes an identification of similarity between the trainee body movement model and the designated trainer body movement model. In another embodiment, the report compares the trainee body movement model to the designated trainer movement model and includes an identification of dissimilarity. In yet another embodiment, the report includes remedial instructional information explaining how to correct the trainee body movement model to conform substantially to the designated trainer body movement models.

Still another embodiment consists of computer storage maintaining a trainer body movement model indicative of movement of trainer reference points in space in which each of the reference points defines a predetermined reference movement path. Also provided is a system for generating a trainee body movement model indicative of movement of trainee reference points in space in which each of the trainee reference points defines a trainee movement path corresponding to one of the trainer movement paths. This embodiment may incorporate alarms, which may be each associated with one of the trainee reference points as well as a computer. The computer compares the trainer movement paths to the trainee movement paths. An alarm is activated if the trainee movement path does not sufficiently correspond to, or otherwise fall within an acceptable range relating to, the trainer movement path. In a particular embodiment, the invention incorporates a close fitting garment, in which the trainee reference points are defined by sensors carried by the close fitting garment, and the alarms are each associated with one of the sensors. Each of the alarms when activated issues an alerting stimulus, such as an audible stimulus, a visual stimulus, and/or a physical stimulus such as a vibrating or electrical stimulus. The garment is preferably a tight-fitting fabric or synthetic suit, but has sufficient “breathing” ability to permit wicking of sweat.

A further embodiment consists of computer storage maintaining a trainer body movement model indicative of movement of trainer reference points in space, in which each of the reference points defines a predetermined trainer reference movement path. There is also a system for generating a trainee body movement model indicative of movement of trainee reference points in space, in which each of the trainee reference points defines a trainee movement path corresponding to one of the reference movement paths. Neuromuscular electrical stimulators, robotic actuators or other physical control mechanisms, preferably carried by a close fitting garment, are each preferably associated with one of the trainee reference points. A computer is also provided for comparing the trainer movement paths to the trainee movement paths. If there is a discrepancy between the movement paths, the neuromuscular electrical stimulators, robotic actuators or other physical mechanisms on the trainee's close fitting garment can be selectively activated to promote corrective movement for the trainee so that the trainee's movement will more closely correspond to the trainer's movement.

Neuromuscular electrical stimulators, robotic actuators and other physical control mechanisms can be placed throughout the trainee garment to impart a movement to the garment or otherwise inhibit a movement of the garment. Neuromuscular electrical stimulators typically take the form of electrodes that are placed on the belly of a trainee's muscles or at either end. By imparting an electrical pulse to the electrodes, the applicable muscle can be caused to contract. Typical pulses are in the range of 1-5 milliamps of alternating current at a frequency of between 1-60 Hz. A gel, such as a hydrogel, can be placed between the electrode and the muscle to make the electrical stimulus more comfortable for the trainee.

Robotic actuators are typically placed near trainee joints to assist in movement of the joints. These robotic actuators can be on the exterior, interior or in a protected sandwiched layer of the garment, or directly on the skin of the trainee and held in place by the garment. An actuator is typically driven by a motor and the operation of motor is controlled by the computer/control unit so as to impart movement to the garment, and hence the trainee wearing it. Alternatively, the robotic actuators could be driven by pneumatic or hydraulic lines controlled by the computer/control unit. When a robotic actuator is activated, the movement of the actuator imparts a movement to the garment or otherwise inhibits a movement of the garment.

The neuromuscular electrical stimulators and robotic actuators preferably work in conjunction with position sensors on the trainee garment. For example, the human arm consists of Deltoid, Biceps, Brachialis, Triceps, Brachioradialis and Extensor Carpi Radialis muscles. The sensors are attached to the garment so as to receive and transmit timely three-dimensional locations of each of these larger muscles, plus smaller muscles, and of the arm joints to reflect a bending, extending, rotating or other movement of the arm. Information about the trainee's body moment as shown by the trainee garment sensors are fed into the computer and used by the computer to determine what corrective stimulation should be provided.

The trainer also preferably uses a close-fitting garment. The trainer garment will typically have a plurality of sensors attached to trainer muscles and joints. These sensors are used to sense the bending, extending, rotating or other movement of the trainer. The sensors are used to feed values into the computer about the trainer's movement which the computer can use to better synchronize the trainee movement with the movement of the trainer.

The trainer garment may also have a plurality of robotic actuators, neuromuscular electrical stimulators or other physical stimulators. These trainer actuators can be operated by the controller to allow the trainer to feel the movements of the trainee. The trainer could use this movement feedback from the trainee to better assess the incorrect movement of the trainee and thereby better instruct the trainee or even modify movement imparted to the trainee garment. For example, after feeling the trainee's movements through stimulators in the trainer garment, the trainer may choose to exaggerate a particular corrective movement to draw the trainee's attention to that corrective movement.

The trainee and trainer garments are preferably made from a lightweight clothing-like orthotics, such as SPANDEX™, with soft actuators, sensors, and electrodes that do not limit the inherent degrees of freedom of the body. Hook and loop fasteners, known as VELCRO™, are preferably used to attach sensors, electrodes and/or robotic actuators to the garments. For example, each of the robotic actuators can be attached to a separate piece of VELCRO™ so that the distance between each robotic actuator can be adjusted to better conform with different trainee body shapes.

Wires or any electrical conducting means can be threaded through holes in the garment, with special care being taken to thread the sensor wires or any conducting means so that their weight will not affect the sensor position. In one embodiment, the wires run up the arm, then into and out of the waist through holes in the garment.

### BRIEF DESCRIPTION OF THE DRAWINGS

FIG. 1 is a schematic representation of a system of the present invention for tracking body movements, including a computer linked to a trainer garment and a trainee garment;

FIG. 2 is another schematic representation in flow chart form of a system of the present invention;

FIG. 3 is a perspective view of the trainee garment of FIG. 1;

FIG. 4 is a perspective view of a trainee holding a fishing pole and wearing a garment present invention;

FIG. 5 is a fragmented perspective view of a fishing pole tip illustrating that a sensor can be attached to the fishing pole;

FIG. 6 is a fragmented perspective view of a portion of the trainee garment illustrating a sensor and an alarm;

FIG. 7 is a perspective view of a golf club illustrating that a sensor can be attached to the golf club;

FIG. 8 is a perspective view of a ring with a sensor that can be worn by the trainee;

FIG. 9 is a perspective view of a glove furnished with sensors that can be used in the present invention;

FIG. 10 is a perspective view of a booty furnished with sensors that can be used in the present invention;

FIG. 11 is a perspective view of a hood furnished with sensors that can be used in the present invention;

FIG. 12 is a fragmented perspective view of a portion of the trainee garment illustrating a robotic elbow actuator;

FIG. 13 is a fragmented perspective view of a portion of the trainee garment illustrating a combination of sensors and a robotic elbow actuator on the trainee garment;

FIG. 14a is a fragmented perspective view of a portion of the trainee garment illustrating a combination of sensors and multiple robotic actuators on the trainee garment;

FIG. 14b is a fragmented perspective view of a portion of the trainee garment illustrating a combination of sensors, robotic actuators and neuromuscular electrical stimulator electrodes on the trainee arm or garment;

FIG. 15 is an electrical schematic representation of a system in accordance with the present invention;

FIG. 16a is a top view of micro-robotic actuator that can be used for the present invention.

FIG. 16b is a side view of the micro-robotic actuator of FIG. 16a.

### DETAILED DESCRIPTION OF THE EMBODIMENTS

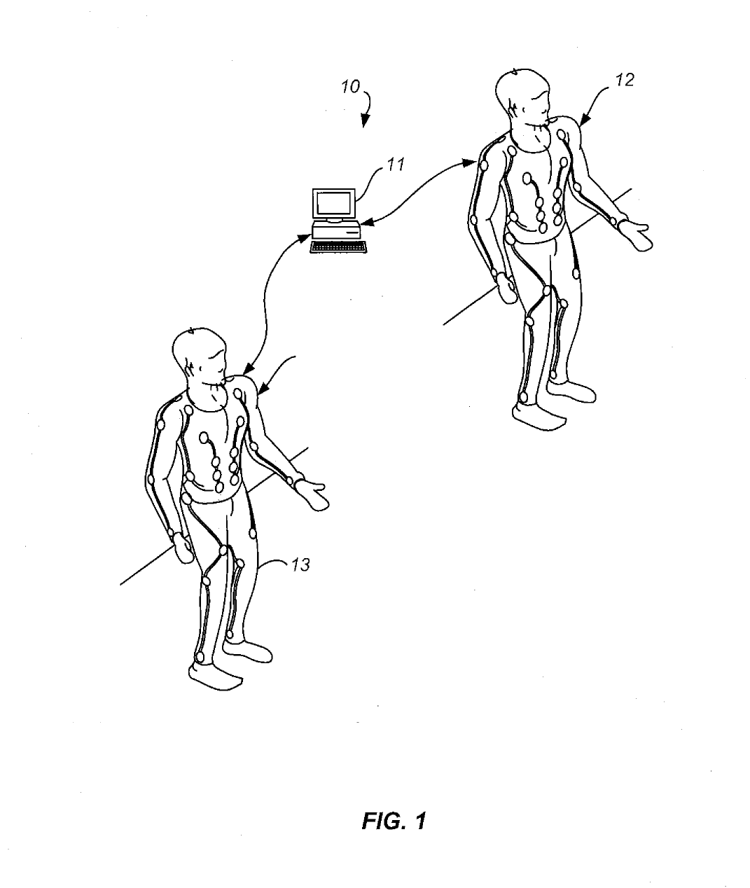

Turning now to the drawings, in which like reference characters indicate corresponding elements throughout the several views. FIG. 1 is a schematic representation of system 10 for tracking body movements including a computer 11 linked to a trainer garment 12 and a trainee garment 13. System 10 accurately tracks body movements of users wearing garments 12, 13, and particularly subtle body articulations, and generates data indicative of the movements, which is integrated into computer 11. Garment 13 is shown in more detail in FIG. 3, and consists of a close-fitting fabric 14 that supports sensors, which are each denoted generally as 15. Sensors 15 are functional for determining the position and orientation of the wearer in space, for monitoring flexure of the articulations of the wearer, and for determining when the wearer is walking, standing, running, etc. Movement by the wearer of garment 13 generates data indicative of the movement for manipulation by a program running on computer 11. To the extent so far described, it is to be understood that trainer garment 12 is substantially identical to trainee garment 13, and that the foregoing discussion of garment 13 applies to garment 12. Sensors 15 are coupled to computer 11 in data communication, and this data communication coupling can be made in any conventional manner, whether by conventional wired and/or wireless interconnections, in which wireless interconnections are preferred as a matter of reducing unwieldy wiring.

The foregoing brief description of system 10 is intended to be generally representative of a typical system operable for tracking body movements and for generating data indicative of body movements. Many such systems for tracking body movement are known in the art, such as that set forth in U.S. Pat. No. 5,963,891 (the '891 patent). System 10, including computer 11 and garments 12, 13, may be constructed and arranged in accordance with the teachings set forth in the '891 patent. Details not specifically illustrated and described will be readily understood and appreciated by those skilled in the art.

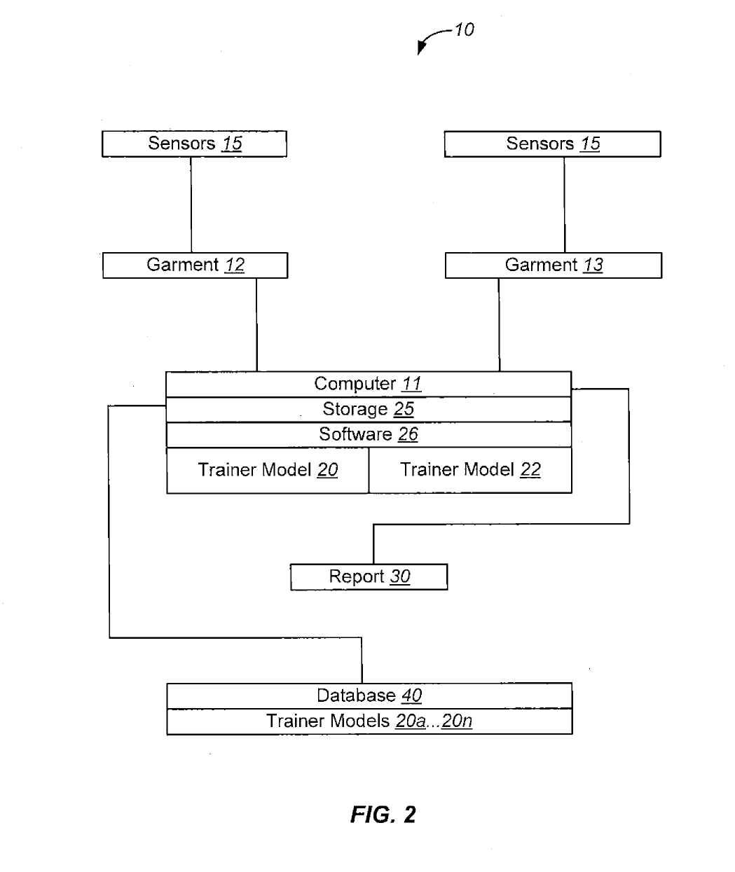

Computer 11 has processing apparatus, an associated output apparatus such as a monitor or display, and input apparatus such as a keyboard, a pointing device, etc. Computer 11 can also be associated with a printer, a scanner, a camera, etc. Computer 11 is furnished or otherwise associated with storage 25 (see, FIG. 2). Storage 25 is resident or local storage and preferably houses, among other things, software 26 of system 10. Storage 25 can house other things, such as a commercially available browser application for facilitating access to and communication with a computer network such as a local area network or the Internet, and an operating system or platform and preferably one that is multi-tasking and responsive to inputs for accessing and interacting with storage and with networked components.

Sensors 15 define reference points in space, in which each of the reference points defines a predetermined reference movement path. In reference to garment 12, the sensors 15 thereof define trainer reference points in space in which each of the trainer reference points defines a trainer reference movement path. In reference to garment 13, the sensors 15 thereof define trainee reference points in space in which each of the trainee reference points defines a trainee reference movement path.

In the use of system 10, garment 12 is to be worn by a trainer or coach, and garment 13 is to be worn by a trainee or student, whether at the same time or at different times. With reference to FIG. 2, the trainer initiates movement and garment 12 tracks the body movement of the trainer to generate data. The computer 11 stores the data as a trainer reference body movement model 20 (hereinafter “trainer model 20”) in storage 25 maintained by or otherwise associated with computer 11. Trainer model 20 is a particular type of movement of the trainer, such as a golf swing, a tennis swing, a fly-fishing cast, a batting swing, a discuss throw, a shot-put throw, a rowing stroke, a dance movement, dance movements, a dance, etc. Computer 11 is programmed by way of software 26 to acquire trainer model 20 and store model 20 into storage 25. Trainer model 20 is indicative of the trainer reference movement paths of the trainer reference points, namely, sensors 15 of garment 12.

The trainee initiates movement and garment 13 tracks the body movement of the trainee wearing garment 13 during the course of the movement. Data is generated commensurate with the tracked body movements and stored as a trainee reference body movement model 22 (hereinafter “trainee model 22”) in storage 25 maintained by or otherwise associated with computer 11. Like model 20, model 22 is a particular type of movement of the trainee, such as a golf swing, a tennis swing, a fly-fishing cast, a batting swing, a discuss throw, a shot-put throw, a rowing stroke, a dance movement, dance movements, a dance, etc. Computer 11 is programmed to acquire trainee model 22 and store trainee model 22 into storage 25. Trainee model 22 is indicative of the trainee reference movement paths of the trainee reference points, namely, sensors 15 of garment 13.

In accordance with the invention, the type of movement indicative of trainer model 20 is the same as trainee model 22. Trainer model 20 is a proper, recommended, or correct movement of a particular type of movement, or, perhaps, a desired movement of a type of movement that a trainee wishes to learn or emulate. After acquiring trainee model 22, computer 11 is responsive, either automatically or manually, to input user commands and in accordance with programming provided by software 25, and compares trainee model 22 to trainer model 20 and generates a report 30 comparing trainee model 22 with trainer model 20. Although only one report 30 is typically generated, a plurality of reports can be generated if desired. Report 30 includes an identification of similarity between trainee model 22 and trainer model 20 and, in addition thereto or optionally, an identification of dissimilarity between trainee model 22 and trainer model 20, e.g., whether the trainee movement paths of the trainee model 22 correspond to, or otherwise fall within an acceptable range relating to, the trainer movement paths of trainer model 20. Report 30 can be accessed by computer 11 as an electronic document and printed from a printer associated with computer 11. After report 30 is generated, it can be stored, either automatically or manually, in storage 25 or elsewhere, such as database 40, for later use. Preferably, report 30 includes remedial instructional information explaining how to correct trainee model 22 to conform substantially to trainer model 20, of which a trainee can use for taking corrective action. The positioning of sensors 15 of garments 12, 13 is substantially identical, so comparisons of trainee and trainer movement models can be accurately made. Typically, report 30 will identify which, if any, of the trainee movement paths correspond to, or otherwise fall within an acceptable or predetermined range relating to, the trainer movement paths of trainer model 20 (such as within 2%, 5%, 10%, etc., of each of the trainer reference movement paths), and which, if any, of the trainee movement paths that do not correspond to, or otherwise fall within an acceptable or predetermined range relating to, the trainer movement paths (such as within 2%, 5%, 10%, etc., of each of the trainer reference movement paths). In this way, an accurate identification of particular problem movement paths in the trainee model 22 can be readily identified.

Report 30 is to be used by the trainee or trainer in examining the similarities and differences between his trainee model 22 and trainer model 20, which allows the trainee or trainer to understand how to correct the trainee's movement for the purpose of helping him conform his movement to correspond substantially to, or otherwise fall within an acceptable range relating to, or otherwise more closely resemble the movement embodied by, trainer model 20. After examining report 30, system 10 can again be used by the trainee to collect a new trainee model, in which a new report is generated comparing the new trainee model 22 to trainer model 20. This process can be repeated by a trainee as many times as necessary for the trainee to effectively train himself to engage in a specific type of movement that conforms substantially to trainer model 20 as provided by the trainer.

A trainee and trainer can use system 10 at the same time, if desired, or at different times. In using system 10 at the same time, the trainer can, for instance, engage in repeated golf swings (or other selected type of movement) for creating repeated trainer models of golf swings, and a trainee can, in accordance with instructions provided by the trainer, engage in repeated golf swings for creating repeated trainee models, in which the trainee models 22 are compared by computer 11 to the trainer models 20 to generate reports useful for teaching the trainee to alter his swing or otherwise correct his swing to better conform with the collected trainer models. In using system 10 at different times, trainer model 20 is stored in storage 25, and accessed by a trainee via computer 11 for comparing collected trainee models to stored trainer model 20.

Although only one trainer model 20 is discussed for storage 25, a potentially vast number of stored trainer models 20a-20n can be provided and, for instance, maintained in a database 40 of storage 25, in which a trainee can use computer 11 to browse through trainer models 20a-20n of database 40 and make desired selections of trainer models in the use of system 10 as previously explained. Stored trainer models can each be different from one another, and can represent movements by different trainers. For instance, stored trainer models can be 1) different golf swings from the same or different trainers (such as golf coaches or professional golfers), 2) different tennis swings from the same or different trainers (such as tennis coaches or professional tennis players), 3) different batting swings from the same or different trainers (such as batting coaches or professional baseball players), etc., to name but a few. In this respect, database 40 can include activity- or subject-specific categories each containing one or more trainer models for a trainer to select from. The activity- or subject-specific categories and/or trainer models can also include identifications of the trainers from whence the trainer models came.

Rather than incorporating sensors 15 with garments 12, 13, sensors 15 can be directly attached to a trainer in the course of use of system 10, and can be directly attached to a trainee in the course of use of system 10. Still, the positioning of sensors to a trainer and a trainee should be substantially identical in order to facilitate accurate comparisons by computer 11 between trainer and trainee models, and between the trainee and trainer reference points. Sensors 15 can be attached to trainees and trainers by way of any desired means. In accordance with the preferred embodiment disclosed herein, garments 12, 13 function as carriers for sensors 15. One or more other types of carriers can be used without departing from the invention.

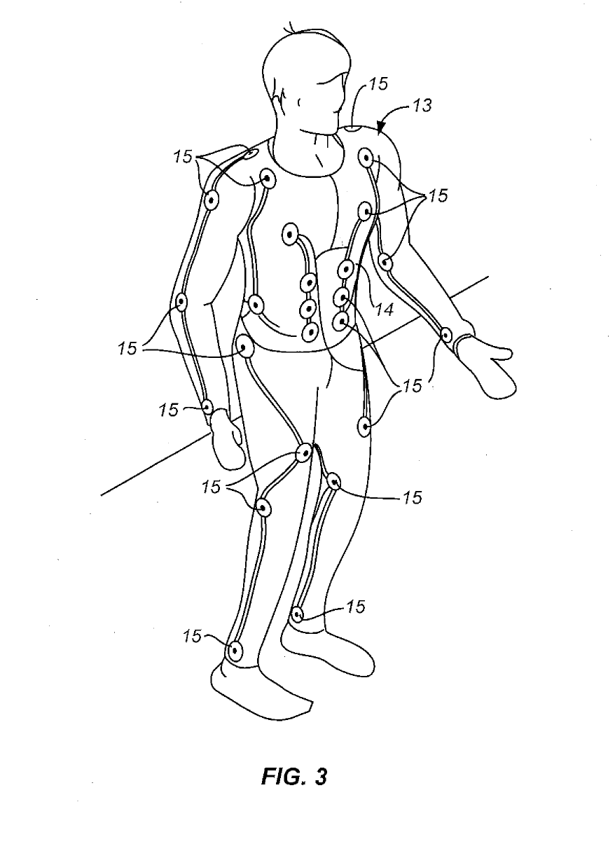

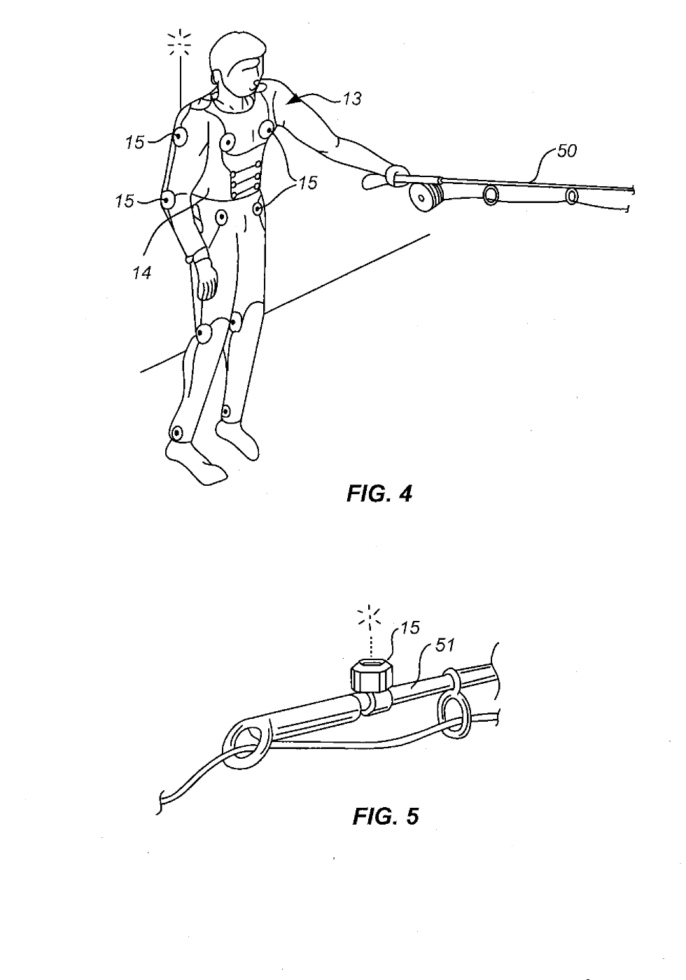

Some activities incorporate the use of tools. For instance, golfing incorporates the use of golf clubs, fly-fishing incorporates the use of a fly rod and line, tennis incorporates the use of a tennis club, etc. In this respect, one or more sensors for use by the trainer can be attached to a tool used by the trainer in the course of the creation of a trainer model so as to track movement of the tool, and this also is true for creation of a corresponding trainee model. To illustrate this point, reference is directed to FIGS. 4, 6 and 7. FIG. 4 illustrates a trainee wearing garment 13, in which the trainee is holding a fly rod 50. FIG. 5 shows a tip 51 of fly rod 50 with a sensor 15 attached thereto for use with system 10. Although fly rod 50 is depicted with only one attached sensor 15, more can be provided at selected positions, if desired. One or more sensors can also be disposed on a fishing line of fly rod so as to track movement of the fly line, and this aspect can be incorporated with a trainer model and for use by a trainee. This can be particularly useful for helping a trainee understand the nature of fly-casting by giving the trainee feedback of how his fly line is translating through space during a casting stroke as compared to the way a fly line is translating through space in a trainer model. A proper fly-casting stroke is often best understood by analyzing the movement of the fly line in space in response to a casting stroke, and so the invention can be particularly useful for teaching trainees the subtleties of fly-casting. The invention can be used with other types of fishing poles.

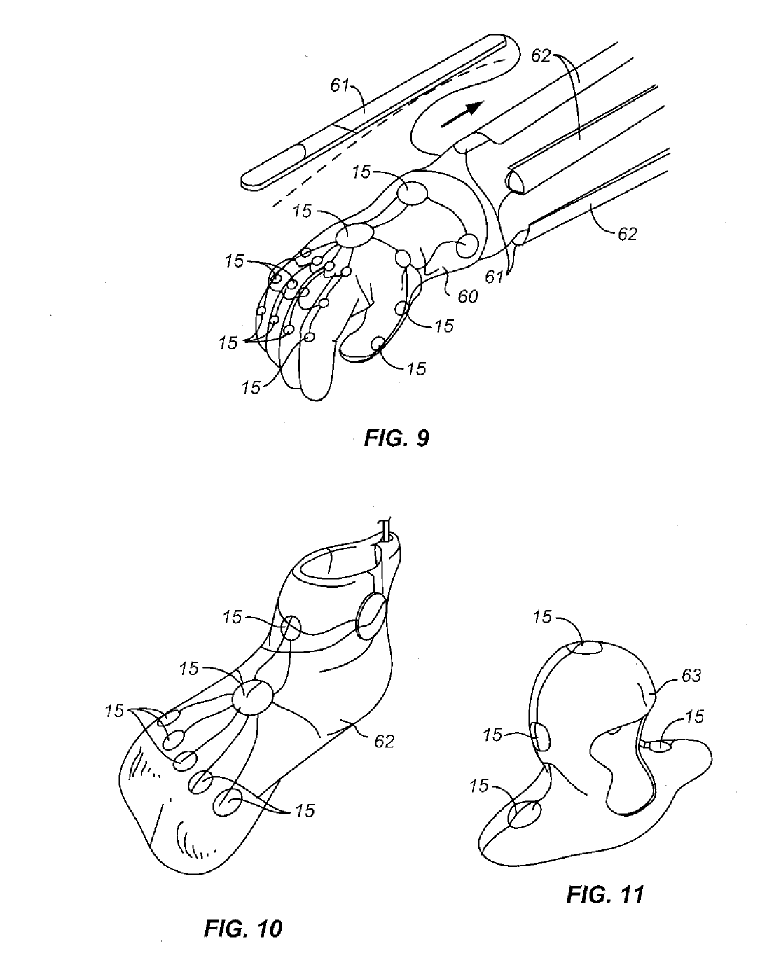

FIG. 7 is a perspective view of golf club 52 having an attached sensor 15 for use with system 10. Although golf club 52 is depicted with only one attached sensor 15, more sensors can be provided at selected positions, if desired. One or more sensors 15 for use with system 10 can be incorporated with other items, such as a ring 60 to be worn on a finger as set forth in FIG. 8, a glove 61 to be worn by hand as set forth in FIG. 9, a shoe or booty 62 to be worn by foot as set forth in FIG. 10, a hat or head covering 63 as set forth in FIG. 11, etc. Other implements and articles can incorporate one or more sensors for use with system 10, as desired. As shown in FIG. 9, disclosed are support spines 61, which are received in sleeves of close-fitting garment 13 for provided added support to garment 13. The provision of splines 61 is an option feature for introducing a certain amount of support or rigidity to close-fitting garment 13. Trainer garment 12 may also be provided with such splines, if desired.

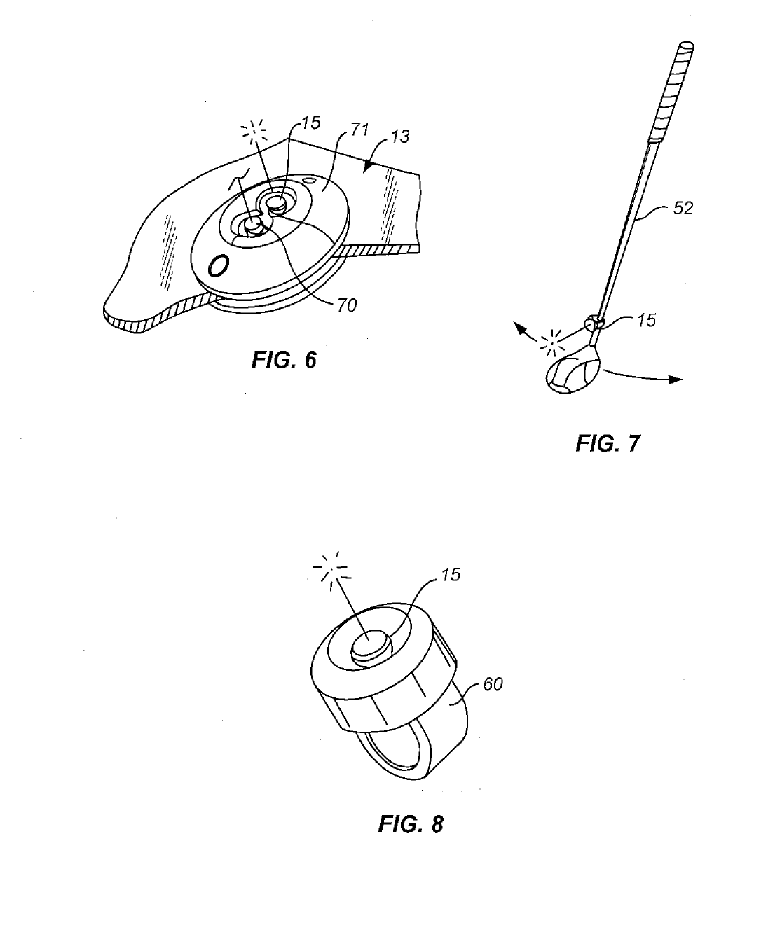

FIG. 6 is a fragmented perspective view of a portion of garment 13 illustrating a sensor 15 and, in accordance with the invention, an alarm 70, which, in this embodiment, are carried by an attached base 71 of garment 13. Alarm 70 and its corresponding sensor 15 can be attached to garment 13 in many ways and even directly to a trainee, if desired. When activated, alarm 70 issues an alerting stimulus, such as an audible stimulus, a visual stimulus (such as a flashing light), and/or a physical stimulus such as a vibrating stimulus, an electrical shock or other applied force to be felt by a trainee wearing garment 13, etc. Alarm 70 can be made to issue any desired alerting stimulus. Alarm 70 is associated with sensor 15 in FIG. 6, and is therefore associated with the trainee reference movement path. In a particular embodiment, alarms 70 are each associated with one of the trainee reference points of garment 13, namely, sensors 15 thereof.

In a comparing event carried out by computer 11 wherein a trainee model is compared to a trainer model, the comparing event can be carried out by computer 11 in real time, in which the trainee model is generated in real time as the trainee initiates a selected movement and is compared real time to trainer model 20 maintained by storage 25. This real time comparison can be initiated manually, or, in accordance with programming provided by software 26, automatically by computer 11 in response to a trainee initiating a selected movement. In this embodiment, computer 11 compares the trainer reference movement paths having the trainer reference points of trainer model 20 to the trainee reference movement paths having the trainee reference points of the trainee model during the course of its acquisition. Computer 11 is responsive to this real-time comparison event, and for each trainee reference point activates its corresponding alarm 70 if the trainee reference movement path thereof does not sufficiently correspond to, or otherwise fall within an acceptable or predetermined range relating to, the trainer reference movement path of the corresponding trainer model 20. When an alarm activates, it indicates to the trainee that the trainee reference point for which it corresponds is outside the corresponding trainer reference movement path of trainer model 20, or otherwise outside of an acceptable or predetermined range or tolerance (such as 2%, 5%, 10%, etc., of the specified trainer reference movement path) of the trainer model 20. This embodiment provides the trainee with immediate feedback as to the competency of the trainee movement paths as compared to the trainer movement paths of the trainer model 20 during the course of the trainee movement. This aspect of the invention need not take place in a real time comparison event. In other words, a trainee model can be acquired after a trainee initiates a movement or swing and then compared to a trainer model, after which one or more of the alarms will activate indicating to the trainee which trainee movement paths as defined by the trainee reference points failed to adequately correspond to, or otherwise fall within an acceptable range relating to the corresponding trainer movement paths of the trainer reference points of the trainer model. Report 30 can also be generated along with the use of alarms as herein described.

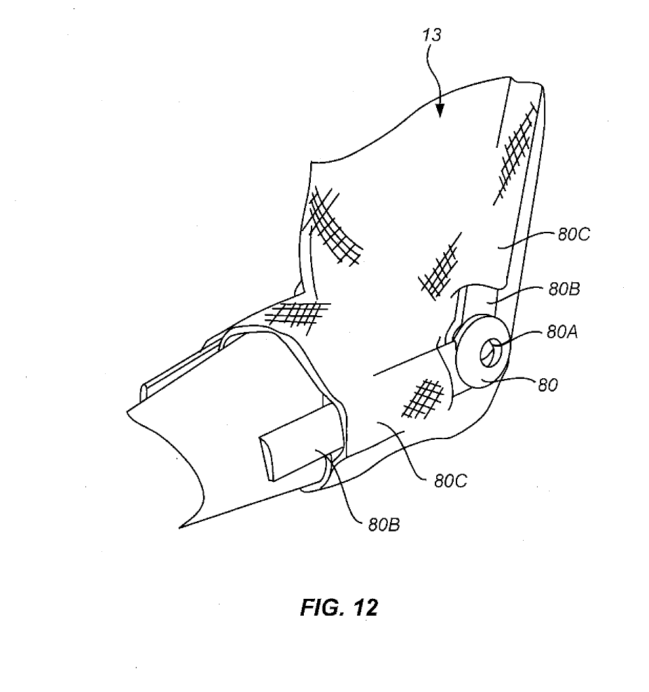

FIG. 12 is a fragmented perspective view of a portion of garment 13 illustrating a robotic actuator 80 associated therewith, namely, an arm portion of garment 13. Robotic actuator 80 is depicted generally arms 80A and 80B that extend into sleeves 80C of garment 13. Actuator 80 is actuated by computer 11 so as to impart movement to arms 80A and 80B. Robotic actuator 80 is conventional and disclosed as a matter of example. It is a mechanical device that is capable of performing a variety of functions under control of the computer 11. When robotic actuator 80 activates, it is made to impart movement to garment 13 or otherwise inhibit movement of garment 13. Although FIG. 12 illustrates only a portion of garment 13 incorporating a robotic actuator, it is intended that the whole of garment 13 can be furnished with robotic actuators, of the same type or of different types, in an embodiment of the invention, so as to be capable of imparting action to garment 13 and to desired portions or features of garment 13, such as to the leg and arm and upper torso portions of garment 13, etc. FIG. 12 is instructive of teachings concerning providing garment 13 with robotic mechanisms.

Any desired robotic mechanisms can be used with the invention consistent with the teachings provided herein, which are operable so as to impart forcible movement. In this respect, it is to be understood that robotic actuators 80, 82 can be a variety of known mechanical devices capable of being activated by computer 11 so as to impart a forcible impulse or movement to garment to cause it to move, to inhibit movement etc. The goal of robotic actuators incorporated within garment 13 is to promote movement of a trainee wearing garment 13 in a particular or desired manner consistent with the trainer movement paths of a trainer model. Consistent with this, any such apparatus capable of performing this function can be used with the invention. It is further envisioned that garment 13 be furnished with instruments capable of imparting involuntary muscle movement, in response to actuation by computer 11, to a trainee wearing garment 13 so as to promote involuntary movement to the trainee in a particular or desired manner consistent with the trainer movement paths of a trainer model, such as trainer model 20. In this respect, garment 13 can incorporate devices capable of generating and delivering applied electrical impulses or other form of energy or impulse to a trainee, which are directed to muscle tissue or elsewhere so as to promote involuntary muscle movement designed to promote a particular type of muscle contraction or movement. Applied electrical pulses can be delivered cutaneously by neuromuscular electrical stimulators, subcutaneously with the use of pins or probes delivered directly into muscle tissue, etc. Other ways of providing involuntary muscle contraction/movement for causing desired movement in a trainee can be used with the invention. Anything associated with garment 13 capable of promoting physical movement to a trainee wearing garment 13 may be considered. It is envisioned that a trainee can wear trainee garment 13 even while sleeping, in which applied electrical or other energy pulses are directed at the trainee so as to stimulate involuntary muscle movements in accordance with a selected trainer model running on the computer in, for instance, a continuous feedback loop, as a means for creating muscle memory.

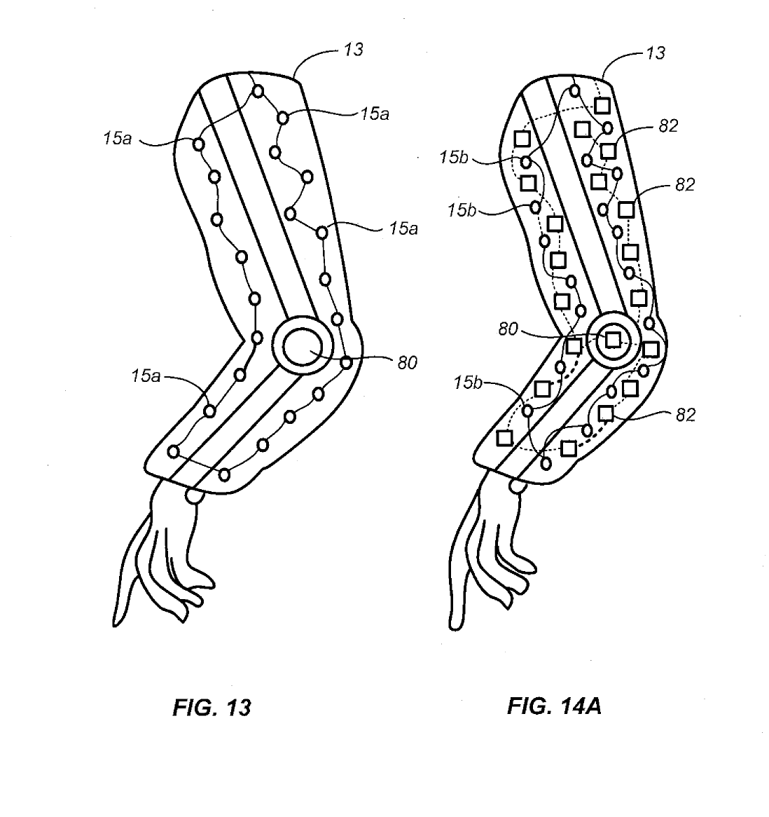

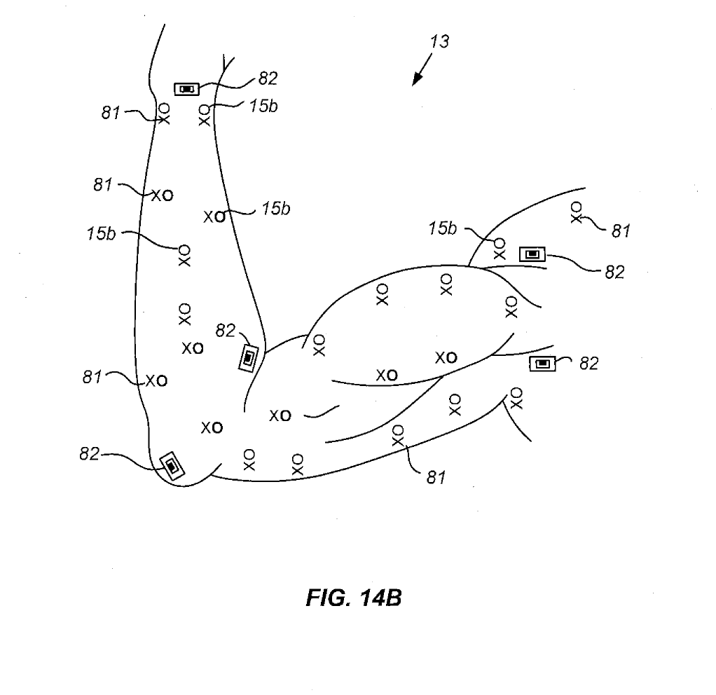

As illustrated in FIGS. 13 and 14a, robotic actuators 80, 82 are each preferably associated with sensors 15 in the trainee garment. Such robotic actuators 80, 82 can be advantageously used at the trainee's joints, for example, to assist in movement of those joints. In comparing events carried out by computer 11 wherein a trainee model is compared to a trainer model, the comparing event is carried out by computer 11 in real time, in which the trainee model is generated in real time as the trainee initiates a selected movement and is compared real time to trainer model 20 maintained by storage 25. This real time comparison can be initiated manually, or, in accordance with programming provided by software 26, automatically by computer in response to a trainee initiating a selected movement. In this embodiment, computer 11 compares the trainer reference movement paths of trainer model 20 to the trainee reference movement paths of the trainee model 22 during the course of its acquisition. Computer 11 in responsive to this real-time comparison event and, as appropriate, for each trainee reference point activates its corresponding robotic actuator 80, 82 to apply a corrective force to correct a movement of the trainee so that the trainee movement path corresponds to that of a trainer movement path. When the robotic actuator 80, 82 activates, it imparts forcible movement to garment 13 or inhibits movement of garment 13 to trainee movement corresponding to trainer reference movement path of trainer model 20. This embodiment provides the trainee with immediate promotion of movement to adjust the trainee movement paths to better correspond to the trainer movement paths of the trainer model 20 during the course of the trainee movement.

A trainee garment 13 can be provided with an onboard computer for use in storing trainer models, acquiring trainee models and/or comparing trainee models to trainer models. A trainer garment can also be provided with its own onboard computer for collecting and storing trainer models, if desired. The invention can also be exploited in a networked computer environment, such as local area network or a generalized computer network, such as the Internet, in which stored trainer models are accessed over the computer network for use by user trainees. In a networked environment, trainer models can be maintained by a networked server or other storage device, in which the stored trainer models are accessed by user clients over a privately or publicly-accessible web site. Also, the invention can incorporate gyroscopes and even satellite data including satellite global positioning data for use in acquiring trainee and trainer models, if desired, and also force platforms for measuring moments along x, y and z axes.

Turning again to FIG. 13, the trainee garment 13 comprises a plurality of sensors 15a. The pluralities of sensors 15a can be fabricated or fitted into the trainee garment to sense the movement of each of muscles. For example, the human arm mainly consists of Deltoid, Biceps, Brachialis, Triceps, Brachioradialis and Extensor Carpi Radialis muscles. In this embodiment, the sensors 15a are fabricated or fitted in the trainee garment 13 so as to receive and transmit timely three-dimensional locations of each of the said larger muscles (as well as smaller muscles) and to the arm joints to sense/determine the bending, extending or rotating angle/movement of the arm. The sensors 15a determine the movement of the arm and feed the values to the computer/control unit.

FIG. 14a and FIG. 14b illustrate a fragmented perspective view of a portion of the trainee garment indicating a robotic mechanism associated therewith for tracking movement of the arm. With respect to FIG. 14a, the trainee garment 13 comprises a plurality of actuators 82 and a plurality of sensors 15b fabricated or fitted on the trainee garment 13. The plurality of actuators 80, 82 in this embodiment are provided for the arm joint and for each of the arm muscles including both larger muscles, such as Deltoid, Biceps, Brachialis, Triceps, Brachioradialis and extensor carpi radialis, and smaller muscles, for achieving an efficient movement of the arm. The plurality of actuators 80, 82 are activated by the computer 11 to impart movement to the arm. A miniature rotary actuator 86 of the type shown in FIGS. 16a and 16b may be used for imparting movement to the arm.

Referring again to FIG. 14a, the trainee garment 13 further comprises a plurality of sensors 15b which may be attached to each of the muscles and/or to the arm joint to sense the bending, extending or rotating movement of the arm. The plurality of sensors 15b determines the movement of the arm and feeds the values to the computer 11 for synchronizing the movement of the arm.

The sensors on the trainer garment 12 and the sensors on the trainer garment 13 are preferably positioned substantially identical in order to facilitate accurate comparisons by computer 11 between the trainer and trainee models, and between the trainee and trainer reference points. The sensors are attached to trainee and trainer garments by way of any desired means. For example, VELCRO™ may be used to attach sensors 15a, 15b and robotic actuators 80, 82. Alternatively, sensors 15a, 15b and robotic actuators 80, 82 can attach to the garment 12, 13 by sewing or gluing. When VELCRO™ is used, each of the robotic actuators 80, 82 can be attached to a separate piece of VELCRO™ so that the distance between each actuator 80, 82 can be adjusted.

The trainee and trainer garments 12, 13 are preferably made from a lightweight clothing-like orthotics, such as SPANDEX™, with soft robotic actuators, sensors and robotic actuator arms that do not limit the inherent degrees of freedom of the arm. In one preferred embodiment, the garment is a tight-fitting like a fabric or synthetic suit but has sufficient “breathing” ability to permit wicking of sweat. The wires or other conducting means to the robotic actuators and/or sensors can be advantageously threaded through holes in or layers of the garment, with special care being taken to thread the sensor wires or conducting means so that their weight will not move and affect the sensor position. The wires or other conducting means may run up the arm, then into and out of the waist through holes in the garment or are contained in a layer of the garment.

FIG. 14b illustrates an embodiment where sensors 15b, robotic actuators 82 and neuromuscular electrical stimulators 81 are used on the trainee garment 13. The neuromuscular electrical stimulators 81 preferably take the form of electrodes and can be located adjacent next to sensors 15b. The robotic actuators 82 can be linear actuators and rotating actuators. As shown in FIG. 14b, for the upper arm, the plurality of sensors 15b and the plurality of neuromuscular electrical stimulator electrodes 81 are preferably placed at the muscle bellies or either end of the shoulder muscle groups comprising deltoid, teres and spinatus muscles. They can also be placed at the muscle bellies or at either end of biceps and triceps muscle groups as well as the tendons and ligaments where those muscles attach to the shoulder and elbow. Similarly, the sensors 15b and neuromuscular electrical stimulator electrodes 81 can be placed at the muscle bellies or either end of the median, ulnar and radial nerves at the shoulder and elbow. For the forearm, placement of the sensors 15b and electrodes 81 can be in the muscle belly or either end of the brachioradialis muscles, the extensor muscles, the forearm flexors and wrist flexors as well as the tendons and ligaments where those muscles attach to the elbow and wrist and/or the median, ulnar and radial nerves at the elbow and wrist. Further the shoulder, elbow and wrist can have one or more rotating actuators 82 and/or one or more linear actuators 82 for enabling multi-directional motion.

In a preferred embodiment, the system further comprises a feedback loop adopted in the control system for smoothly replicating multi-dimensional human movement. For example, as stimulus is being provided to the trainee, the trainee's movements as reflected by the trainee sensors 15a, 15b can be recorded to determine how effectively the stimulus is being applied. Based upon the feedback provided by the trainee sensors 15a, 15b, the stimulus may either be increased, decreased or maintained at the same level. These feedback loops will be a part of the control system for guiding instructions to obtain the desired output based on the observed deviations from the preferred behavior. Another form of feedback can be provided if the trainer is equipped with a forcible movement garment of the same sort worn by the trainee. With such a forcible movement garment, the trainer can feel the erroneous movements made by the trainee and, in response, exaggerate corrective movements so that the trainee will get a stronger sense through the trainee's corrective movement garment of how the trainee's movements need to be corrected.

The placement of the robotic actuators 80, 82, sensors 15a, 15b and/or electrodes 81 on the trainer and trainee garments 12, 13 can be varied since every individual reacts slightly differently to stimulation based on fatigue, muscle size, muscle soreness and/or contraction speed. For the electrodes 81 in particular, the locations should be chosen to achieve the most efficient stimulation. The expected ranges for electrical current amplitude and frequencies are roughly in the range of 1-5 milliamps of alternating current at 1-60 Hertz.

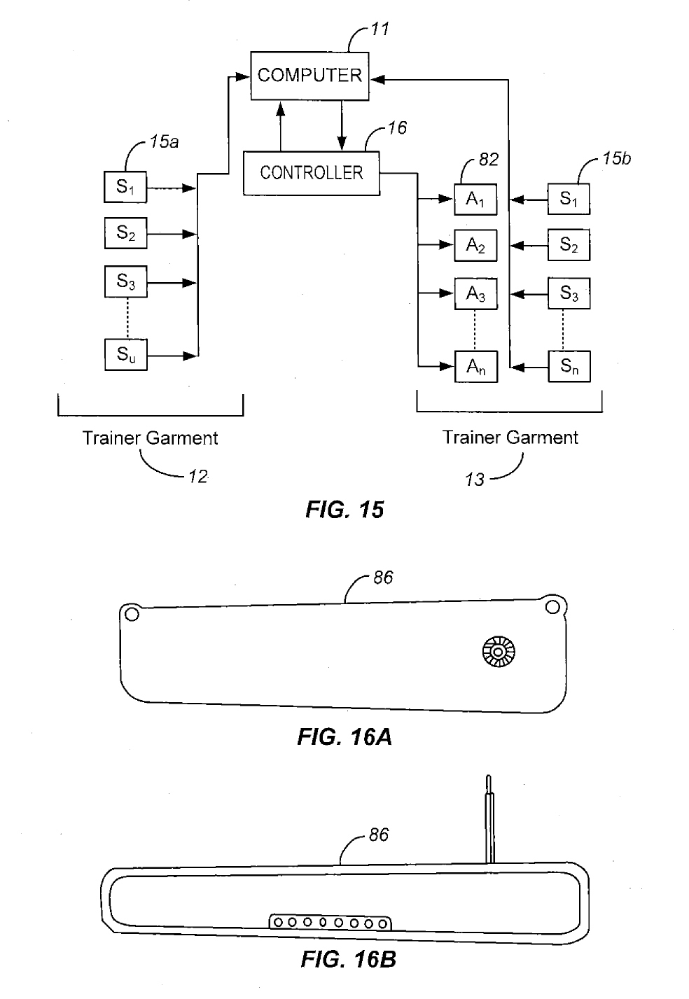

FIG. 15 is a block circuit diagram for the system of the present invention. The sensors 15a in the trainer garment 12 track the body movement of the trainer and generate data commensurate with the tracked body movements which can be provided to computer 11. Similarly, the sensors 15b in the trainee garment 13 track the body movement of the trainee and generate data commensurate with the tracked body movements which can be provided to computer 11. Based upon this trainee data, robotic actuators 82 (or neuromuscular electrical stimulators) can be activated by controller 16 to assist the trainee in better replicating the trainer's body movements.

FIGS. 16a and 16b are a top view and a side view, respectively, of a robotic micro-actuator 86. The micro-actuator 86 can, for example, be a rotatory micro-actuator or a linear micro-actuator. The micro-actuator 86 as shown in FIGS. 16a and 16b is light, inexpensive and consumes less power than larger actuators.

The advanced training system and method of the present invention provides graduated steps to conform the trainee's imperfect movement to the trainer's more perfect movement. The method of the present invention may further comprise a recording-observer model to track in 3D the trainer's movements and to store the movement instructions in the computer. The method of the present invention improves the power, velocity and accuracy of the trainee's movements and refines those movements.

In the foregoing specification, the invention has been described with reference to specific preferred embodiments and methods. It will, however, be evident to those of skill in the art that various modifications and changes may be made without departing from the broader spirit and scope of the invention as set forth in the appended claims. The specification and drawings are, accordingly, to be regarded in an illustrative, rather than restrictive sense; the invention being limited only by the appended claims.

What is claimed is:

1. A system to assist a trainee in replicating the body movements of a trainer comprising:
a record stored in a computer of a trainer's body movements;
a garment for a trainee having a plurality of sensors and a plurality of neuromuscular electrical stimulators;
wherein said computer assists said trainee in replicating the body movements of said trainer by assembling data from said trainee's garment sensors about said trainee's body movement, using said data to compare said trainee's body movement with the stored record of said trainer's body movement and selectively actuating said neuromuscular electrical stimulators to assist said trainee in replicating the body movements of said trainer.

2. The system of claim 1, wherein said computer generates a report comparing the trainee body movements with the trainer body movements.

3. The system of claim 1, wherein said neuromuscular electrical stimulators are attached to said trainee's muscles.

4. The system of claim 3, wherein a pulse of alternating electrical current is sent through a neuromuscular electrical stimulator to cause the contraction of a trainee muscle.

5. The system of claim 4, wherein said alternating electrical current pulse is between 1-5 milliamps at a frequency of between 1-60 Hertz.

6. The system of claim 1, wherein said neuromuscular electrical stimulators are threaded through holes in said trainee garment and placed in contact with the trainee's skin.

7. The system of claim 1, wherein said neuromuscular electrical stimulators are attached either to the belly of a muscle or the end of a muscle.

8. The system of claim 1, wherein said neuromuscular electrical stimulators are attached to one or more of the following muscle groups: Deltoid muscle, Biceps muscle, Teres muscle, Spinatus muscle, Brachialis muscle, Triceps muscle, Brachioradialis muscle and Extensor Carpi Radialis muscle.

9. A system to assist a trainee in replicating the body movements of a trainer comprising:
a record stored in a computer of a trainer's body movements;
a garment for a trainee having a plurality of sensors, neuromuscular electrical stimulators and robotic actuators;
wherein said computer assists said trainee in replicating the body movements of said trainer by assembling data from said trainee's garment sensors about said trainee's body movement, using said data .to compare said trainee's body movement with the stored record of said trainer's body movement and selectively actuating said neuromuscular electrical stimulators and/or robotic actuators to assist said trainee in replicating the body movements of said trainer.

10. The system of claim 9, wherein said robotic actuators are selected from the group consisting of linear robotic actuators and rotary robotic actuators.

11. The system of claim 9, wherein said neuromuscular electrical stimulators are used to primarily move the trainee's muscles and said robotic actuators are used primarily to move said trainee's joints.

12. The system of claim 9, wherein said garment is a tight-fitting, yet breathable, fabric or synthetic suit.

13. A trainee garment comprising:
a body suit having a plurality of sensors, neuromuscular electrical stimulators and robotic actuators;
wherein said sensors can be used to provide information to a computer about said trainee's movements, said neuromuscular electrical stimulators can be used to provide electrical pulses to selected trainee muscles to cause their contraction and said robotic actuators can be used assist movement of a trainee's joints.

14. The garment of claim 13, wherein said neuromuscular electrical stimulators and said robotic actuators are computer controlled and used to help a trainee wearing said body suit to better replicate the body movements of a trainer.

15. The garment of claim 14, wherein said computer stores a record of a trainer's body movements.

16. The garment of claim 13, wherein said garment is a tight-fitting, yet breathable, fabric or latex suit.

17. A system to assist a trainee in replicating the body movements of a trainer comprising:
a garment for both a trainee and a trainer having a plurality of sensors, neuromuscular electrical stimulators and robotic actuators;
a computer which uses said sensors to track the body movements of said trainer and trainee wherein said computer is also capable of activating said neuromuscular electrical stimulators and/or robotic actuators in said garments to forcibly change the body movements of said trainee or trainer.

18. The system of claim 17 wherein said computer forcibly changes the body movements of said trainee to better correspond with the body movements of said trainer.

19. The system of claim 17 wherein said computer forcibly changes the body movements of said trainer to correspond to the movements of said trainee to better assist said trainer in identifying the erroneous body movements of said trainee.

20. The system of claim 17 wherein said computer uses information from said sensors to assess the effectiveness of forcible movements imparted by said neuromuscular electrical stimulators and robotic actuators so that such stimulus can be increased, decreased or left at the same levels as appropriate.
